(19) United States
(12) Patent Application Publication
(10) Pub. No.: US 2025/0258763 A1
(43) Pub. Date: Aug. 14, 2025

(54) Co-simulation for System-on-Chip

(71) Applicant: Microsemi SoC Corp., Chandler, AZ (US)

(72) Inventors: Stefan Hadjis, Toronto (CA); Jongsok Choi, Richmond Hill (CA)

(73) Assignee: Microsemi SoC Corp., Chandler, AZ (US)

(21) Appl. No.: 18/895,528

(22) Filed: Sep. 25, 2024

Related U.S. Application Data
(60) Provisional application No. 63/551,495, filed on Feb. 8, 2024.

(51) Int. Cl. G06F 11/36; G06F 9/54

(52) U.S. Cl. CPC G06F 11/3698; G06F 9/54

(57) ABSTRACT

A non-transitory computer readable medium is provided comprising instructions that when executed on a processor load a software program into a software debugger for execution on an emulated processor representing a processor portion of a system on chip (SoC), load a hardware design into a hardware simulator representing a programmable gate array portion of the SoC, coordinate execution of software debugger and hardware simulator to simulate operation of the SoC, communicate data between the software debugger and the hardware simulator, and display computed results and current values.

### RELATED PATENT APPLICATION

The present application claims priority to commonly owned U.S. Provisional Patent Application No. 63/551,495, filed Feb. 8, 2024, which is hereby incorporated by reference herein for all purposes.

### FIELD OF THE INVENTION

The present application relates to systems and methods for developing and testing High-Level Synthesis (HLS) designs targeting system-on-chip (SOC) field programmable gate array (FPGA) devices.

### BACKGROUND

Modern Field-Programmable Gate Arrays (FPGAs) may provide System-On-Chip (SoC) devices with a processor on the same die as the FPGA fabric. SoC FPGAs enable new use cases for FPGAs, such as SoC designs with processor and hardware accelerators on a single chip (as shown in FIG. 1). HLS allows a software program described in a common programming language such as C, C++, or Tcl to be compiled to a hardware definition language (HDL). High-Level Synthesis (HLS) allows a software program to be compiled into a hardware circuit, and HLS tools, such as SmartHLS and PolarFire System, can perform system integration to generate processor/accelerator SoC designs from software. HLS compilation may generate a register transfer level (RTL) hardware circuit design that may be translated into FPGA configuration settings to implement a hardware design.

One challenge facing SoC designers is the verification and debugging of the design. When errors exist in a complex SoC design, it can be difficult to know if errors are in the software, hardware, or both. Software debuggers such as GNU Debugger (GDB) cannot be used to debug the hardware or the software/hardware interface. RTL simulators cannot verify the software. Moreover, existing debuggers and simulators cannot debug the communication interface between the processor and FPGA fabric. On-chip debuggers may be used to monitor a limited number of hardware signals on the chip and only after hours of synthesis, place, and route time to implement the design on the FPGA device. This makes on-chip debugging extremely difficult and time consuming. In addition, on-chip debugging requires access to an FPGA board, which may not be readily available in early phases of the design.

### SUMMARY

In some examples, a non-transitory computer readable medium is provided comprising instructions that when executed on a processor load a software program into a software debugger for execution on an emulated processor representing a processor portion of a system on chip (SoC), load a hardware design into a hardware simulator representing a programmable gate array portion of the SoC, coordinate execution of software debugger and hardware simulator to simulate operation of the SoC, communicate data between the software debugger and the hardware simulator, and display computed results and current values. In some examples, the non-transitory computer readable medium comprises instructions that when executed on the processor, within the software program executed in the software debugger, designate a variable as a memory value in the hardware simulator, and after an execution step in the software debugger, set the variable in the software debugger to the current value read from the hardware simulator. In some examples, the non-transitory computer readable medium comprises instructions that when executed on the processor open a socket connection between the software debugger and the hardware simulator to communicate values on a simulated data bus. In some examples, the non-transitory computer readable medium comprises instructions that when executed on the processor convert a portion of the software program into the hardware design. In some examples, the non-transitory computer readable medium comprises instructions that when executed on the processor visually present at least one input to a function call to be transmitted over a socket to the hardware simulator, and visually present an output of the function call received over the socket from the hardware simulator. In some examples, the non-transitory computer readable medium comprises instructions that when executed on the processor emulate memory mapped peripherals accessible to the software program. In some examples, the software program is written in C or C++ code and the hardware design is specified in RTL code.

In some examples, a computer implemented method is provided comprising loading a software program into a software debugger for execution on an emulated processor, loading a hardware design into a hardware simulator, coordinating execution of software debugger and hardware simulator to simulate operation of a device comprising a processor and a programmable gate array, communicating data between the software debugger and the hardware simulator, and displaying computed results and memory values. In some examples, the computer implemented method comprises, within the software program executed in the software debugger, designating a variable as a memory value in the hardware simulator, and after an execution step in the software debugger, setting the variable in the software debugger to the memory value read from the hardware simulator. In some examples, the computer implemented method comprises opening a socket connection between the software debugger and the hardware simulator to communicate values on a simulated data bus. In some examples, the computer implemented method comprises accepting an input from a user to advance execution of the software debugger over a call to a function that was written in the same language of the software program and implemented the hardware design; sending one or more arguments from the processor emulator to the hardware simulator; receiving a result from the hardware simulator to the processor emulator; and displaying the result to the user. In some examples, the computer implemented method comprises displaying at least one input to a function call to be transmitted over a socket to the hardware simulator, and displaying an output of the function call received over the socket from the hardware simulator. In some examples, the computer implemented method comprises emulating memory mapped peripherals accessible to the software program. In some examples, the software program is written in C or C++ code and the hardware design is specified in RTL code.

In some examples, a non-transitory computer readable memory is provided comprising instructions that when executed on a processor receive into a software debugger a software partition of a software program, establish a first socket connection between the software debugger and a hardware simulator to simulate a hardware design corresponding to the software partition, and execute the software partition of the software program on an emulated processor. In some examples, the non-transitory computer readable memory comprises instructions that when executed on a processor establish a second socket connection between the software debugger and an input/output interface. In some examples, the non-transitory computer readable memory comprises instructions that when executed on a processor within the software program executed in the software debugger, designate a variable as a memory value in the hardware simulator, and after an execution step in the software debugger, set the variable in the software debugger to the memory value read from the hardware simulator. In some examples, the non-transitory computer readable memory comprises instructions that when executed on a processor accept an input from a user to advance execution of the software debugger over a call to a function that was written in the same language of the software program and used to implement the hardware design; send one or more arguments from the processor emulator to the hardware simulator; receive a result from the hardware simulator to the processor emulator; and display the result to the user. In some examples, the non-transitory computer readable memory comprises instructions that when executed on a processor display at least one input to a function call to be transmitted over the first socket connection to the hardware simulator, and display an output of the function call received over the first socket connection from the hardware simulator. In some examples, the non-transitory computer readable memory comprises instructions that when executed on a processor emulate memory-mapped peripherals accessible to the software program.

### BRIEF DESCRIPTION OF THE DRAWINGS

FIG. 1 is an illustration of an SoC under simulation, according to certain examples.

FIGS. 2-9, 11, 14, and 16-18 illustrate screens of an integrated development environment including a co-simulation framework, according to certain examples.

FIG. 10 is a block diagram of the co-simulation framework, according to certain examples.

FIG. 12 is an illustration of a memory map, according to certain examples.

FIG. 13 is an illustration of source code, according to certain examples.

FIG. 15 is a flowchart of a method for performing a co-simulation, according to certain examples.

FIG. 19 illustrates a software system, according to certain examples.

### DETAILED DESCRIPTION

The present high-level synthesis (HLS) reduced instruction set computer five (RISC-V) system on a chip (SoC) Co-Simulation Framework addresses challenges facing SoC designers. A design tool is provided to receive a C/C++ program to generate a RISC-V processor/accelerator SoC design. The design tool partitions the C/C++ program into software and hardware partitions. The hardware partition may be compiled into hardware accelerators with HLS. For example, the hardware portion may be implemented in an FPGA fabric on the SoC. The software partition is presented for execution on a CPU in the SoC. In some examples, the CPU may be a RISC-V processor. RISC-V is an open-source instruction set architecture. In some examples, the RISC-V processor system and hardware accelerators are integrated to create a RISC-V processor/accelerator SoC design.

Using this HLS RISC-V SOC Co-Simulation Framework, the entire RISC-V processor/accelerator SoC design may be verified automatically without running synthesis, place and route, or using an on-chip debugger, or using an FPGA board. This co-simulation framework provides complete visibility into both software and hardware, allowing users to debug the entire SoC design and significantly speeding up the debug process. To do this, the same software binary which would run on the processor on the FPGA board runs on a RISC-V emulator. The RISC-V emulator is a software tool that emulates the execution of software on the RISC-V processor. The hardware components of the SoC design are simulated concurrently using an RTL simulator. Using an RTL simulator provides visibility into the entire hardware design, without being limited to a select number of signals and without going through synthesis, place and route. The RISC-V emulator and the RTL simulator communicate using transfer control protocol (TCP) sockets over the local network, allowing software to communicate with hardware. This communication uses the same Advanced extensible Interface (AXI) transfer protocol and mimics the on-chip communication which exists between the processor and the FPGA hardware.

Overall, this co-simulation framework allows an entire HLS SoC design to be verified easily and quickly, making SoC FPGAs more accessible.

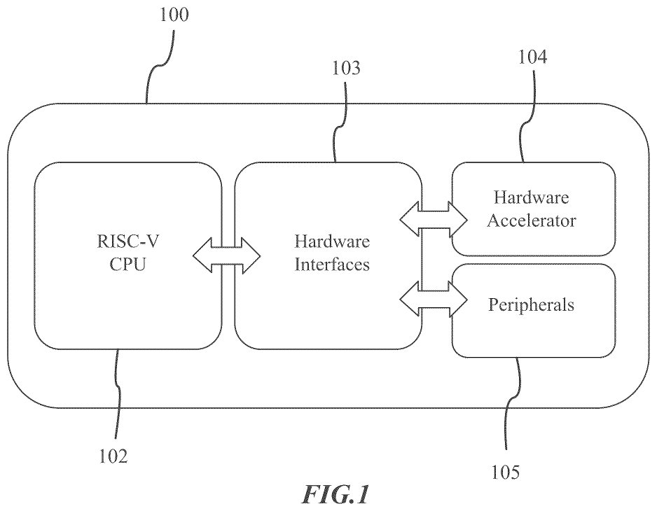

FIG. 1 is an illustration of an SoC under simulation, according to certain examples. System 100 includes emulated processor 102, emulated hardware interfaces 103, simulated hardware accelerator 104, and emulated peripherals 105. Emulated processor 102 may represent a general-purpose processor such as a RISC-V central processing unit (CPU) that is embedded in a system on a chip (SoC) device. SoC devices may be embedded in systems such as automobiles, consumer electronic devices, and industrial control devices. In some examples, simulated hardware accelerator 104 may be a configurable hardware fabric such as a field programmable gate array (FPGA) fabric. Simulated hardware accelerator 104 may implement custom digital logic that may solve certain computational or control problems faster than software executing on a processor. In some examples, simulated hardware accelerator 104 may solve certain computational or control problems more efficiently than software executing on a processor. Simulated hardware accelerator 104 may include memory elements accessible by emulated processor 102 via an emulated data bus. These simulated memory elements may be memory mapped and accessible directly by instructions executing on emulated processor 102. System designers may implement custom digital logic by providing a software description of that logic and employing a high-level language synthesis (HLS) tool to generate an FPGA configuration for the hardware logic. The software description may be provided in code written in a high-level language such as C, C++, or Tel. Emulated peripherals 105 may include, for example, modules for interacting with hardware external to the SoC. For example, emulated peripherals 105 may include a flash memory controller, an I2C (inter-integrated circuit) controller, a general-purpose input/output (GPIO) interface, a universal serial bus (USB) controller, and an ethernet media access controller (MAC).

Use of the term FPGA is not intended to limit the present disclosure to “field programmable” devices. The co-simulation techniques could also be used to validate and verify designs intended for gate arrays that are one time programmable as well as those that are configured through a non-reversable fabrication process.

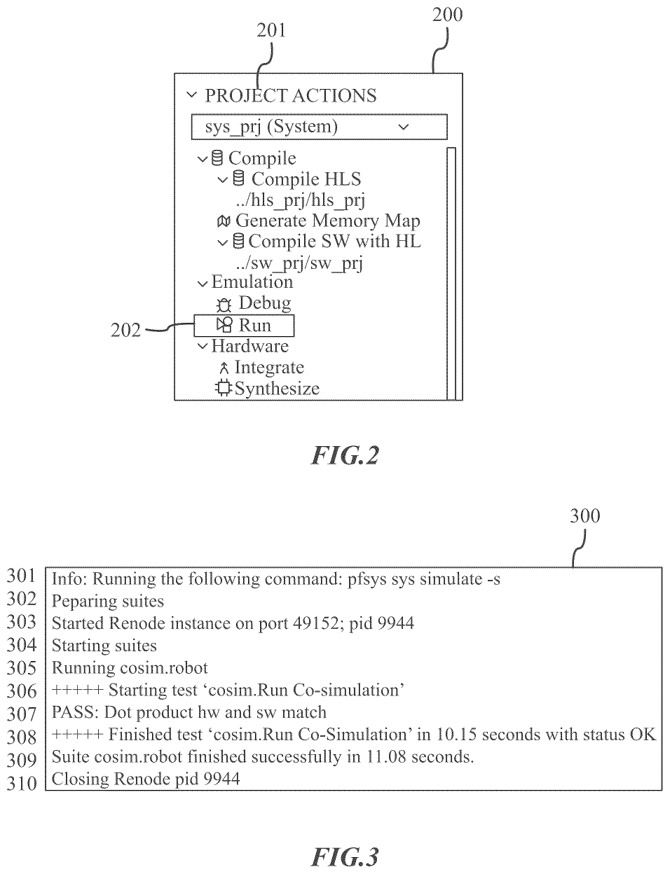

FIG. 2 illustrates a screen of an integrated development environment (IDE) including a co-simulation framework, according to certain examples.

This co-simulation framework may allow software to run in emulation while the hardware is simulated using an RTL simulator. The correctness of an entire SoC design may be verified without executing the design on a board. FIG. 2 illustrates how the SoC co-simulation may be launched from IDE 200. IDE 200 includes a set of project actions 201 applicable to the currently selected project “sys_prj.” In certain examples, the co-simulation may be launched by clicking on “run” button 202 of Emulation in a System project. This action may launch the SoC co-simulation, which may automatically run the software on a RISC-V emulator, simulate hardware in an RTL simulator, and provide inter-process communication over TCP sockets. Any outputs, such as log messages from simulation or print statements from user's software, may be printed to a terminal interface.

Other functions may be performed in this view of IDE 200. For example, compile may include a compile high level synthesis (HLS) function and a compile software (SW) function. Compile HLS may extract designated hardware-specific portions of a source code file into register transfer language (RTL), a programmable gate array configuration, or other hardware description. These designated hardware-specific portions may be designated with specific statements (e.g., “pragma” statements). Compile SW may compile the remainder of the source code (e.g., excluding the designated hardware-specific portions) into object code (which can be linked into executable software code) or into executable software code targeting the architecture of the SoC processor (e.g., RISC-V). A generate memory map function may generate a mapping of hardware specific memory locations and corresponding variables accessible to the executable software code. The emulation functions may include debug (which may begin the emulation process and wait before executing any instructions) and run 202 (which may begin the emulation process and execute instructions until a breakpoint is reached or error occurs). Source code may include one or more source code files, include files, header files, and library files. Hardware functions include integrate and synthesize, which may be invoked after the design has been validated in the simulator. Integration may involve generating the final design which will run on the FPGA. This design may include hardware components that the co-simulation previously just verified in emulation. Synthesize may then perform a compilation step to convert this FPGA design into a bitstream that can be programmed on the FPGA.

In some examples, the IDE receives a C/C++ program as input to generate software and hardware components of an SoC design. The HLS RISC-V SoC Co-Simulation framework may be used to verify the SoC design.

### SoC Design Overview:

The frontend compiler may transform the input program to call the software driver functions that will be generated to invoke hardware accelerators instead of executing the functions in software. In some examples, CLANG is used as the frontend compiler (CLANG is an open-source compiler). The HLS system may automatically generate software driver functions, which handle data transfers to hardware accelerators, invoke the hardware accelerators, and retrieve computed results. The transformed software and generated software driver functions form the software partition, which may be compiled with a RISC-V compiler toolchain into a software binary to execute on a RISC-V processor. For example, in a vector addition application, this binary may be called vec_add.elf. The hardware partition may perform a series of compiler optimizations to generate a hardware accelerator described in, for example, the Verilog hardware description language (Verilog HDL). For a vector addition application, this hardware accelerator file may be called vec_add.v.

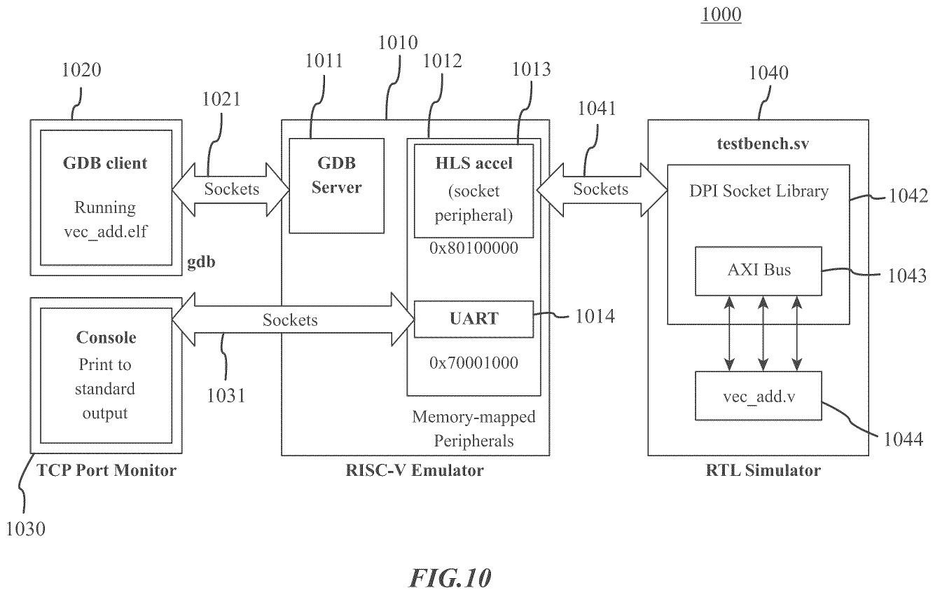

Users may also print program outputs from their software application. On a physical RISC-V processor on a board, this output may be transmitted serially through a UART (universal asynchronous receiver-transmitter) communication channel. In emulation, this UART device is modeled as a peripheral device. This emulated device writes the serialized data to a TCP socket. To receive UART output and print its data to a terminal, a TCP port monitor may be used (shown in FIG. 10). This is a process that is run as part of the co-simulation to read data from the TCP port and display the serialized output to the user.

FIG. 3 illustrates a screen of an integrated development environment (IDE) including a co-simulation framework, according to certain examples. Console 300 illustrates print statements 301-310 shown in the output console of the IDE, according to certain examples. Print statement 301 reports the command executed to initiate the co-simulation in a software development framework such as the Renode™ development framework. Print statement 302 reports the co-simulation is ready to load the specified test suites. Different ways of running co-simulation can be organized into different test suites to allow users to debug according to their requirements. For example, one test suite can run co-simulation with waveforms shown but without launching the software debugger. Another test suite can only launch the debugger but not display waveforms. A third test suite can enable both. Print statement 303 reports starting a co-simulation process listening to transport control protocol (TCP) port 49152 and reports the process identifier for that co-simulation process. Print statement 304 reports starting the co-simulation suites. Print statement 305 reports initiation of a test suite named “cosim.robot”, which is a test suite created using an automation framework for test and process automation such as the ROBOT FRAMEWORK. Print statements 306 and 308 report the start and finish of the “cosim” test, which may be defined in the “cosim.robot” test suite. Print statement 307 reports the simulation passes where a dot product implementation in hardware and software have the same result. Print statement 309 reports the successful completion of the “cosim.robot” test suite. Print statement 310 reports the end of the co-simulation process.

Console 300 allows the user to verify if the expected result is achieved, indicating that the processor/accelerator SoC design has correctly executed. If the result is not correct, this may indicate an error in the SoC design. A user may then enter a debugging mode in the IDE. This can be done by stepping through the software running in RISC-V emulation with GDB and by examining the waveforms of the hardware from RTL simulation.

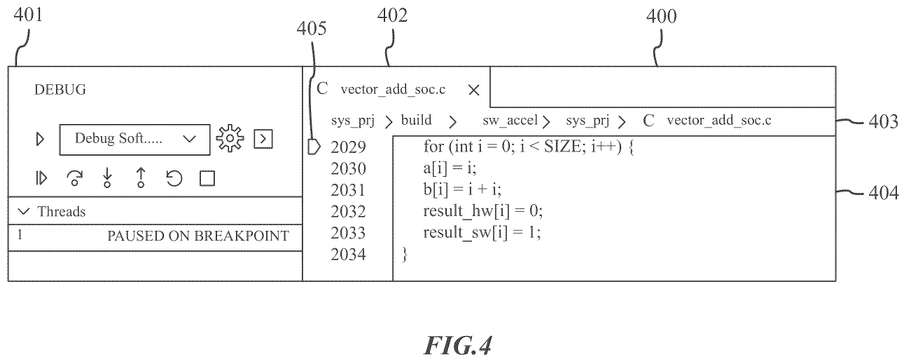

FIG. 4 illustrates a screen of an integrated development environment (IDE) including a co-simulation framework, according to certain examples. IDE 400 includes control panel 401, source code tab 402, file path indicator 403, lines of source code 404, and current line indicator 405. Control panel 401 may include controls for stepwise executing the co-simulation through individual software instructions, executing the co-simulation process until an error occurs or a breakpoint is reached, stepping into a function, stepping over a function, resetting the co-simulation, and stopping the co-simulation. Control panel 401 may include a settings button for adjusting the settings for the co-simulation. Source code tab 402 may display the file path indicator 403 and lines of source code 404. Current line indicator 405 marks the location in a source code file where the co-simulation will next execute an instruction. IDE 400 shows how the software executing on a RISC-V emulator can be debugged with GDB to examine program variables as well as values of the RISC-V registers.

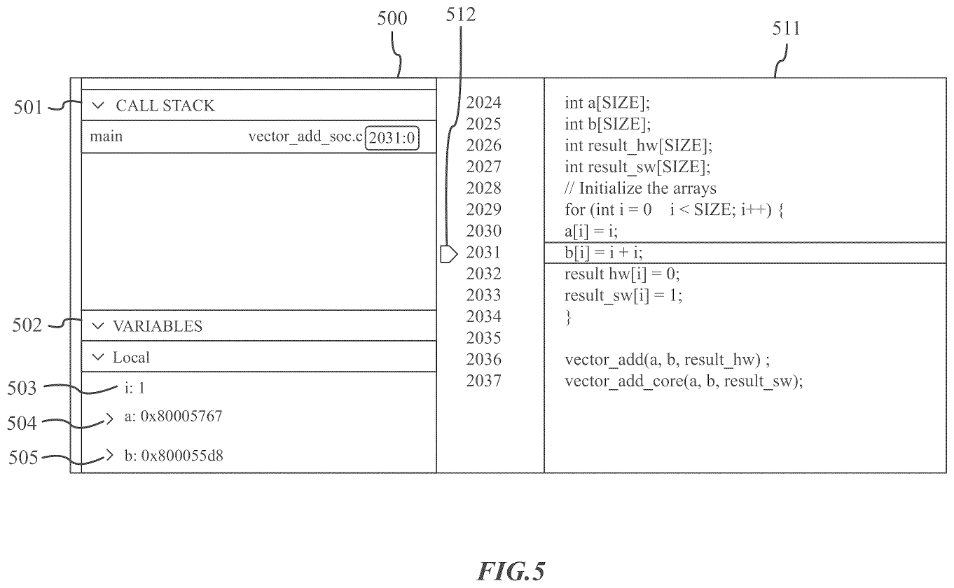

FIG. 5 illustrates a screen of an integrated development environment (IDE) including a co-simulation framework, according to certain examples. IDE 500 includes call stack panel 501, variables panel 502, variables 503-505, source code listing 511 and current line indicator 512. Call stack panel 501 indicates the current co-simulation process has advanced to line 2031 in the main function defined in vector_add_soc.c. Variables panel 502 visually presents the current values of three variables. Variable 503 is labeled “i” and is illustrated as having an integer value of 1. Variables 504 and 505 are pointers to arrays of integers and are illustrated as pointing to two different memory locations. In some examples, the arrow indicator to the left of variable 504 may be used to expand the display in variables panel 502 and show the contents of the integer array below the address value. Source code listing 511 highlights line 2031 as the current line of execution. In some examples, the user may move the pointer over a variable in source code listing 511 and IDE 500 will show the current value of that variable in a floating display element. IDE 500 shows how the software executing on a RISC-V emulator can be debugged with GDB to examine program variables as well as values of the RISC-V registers.

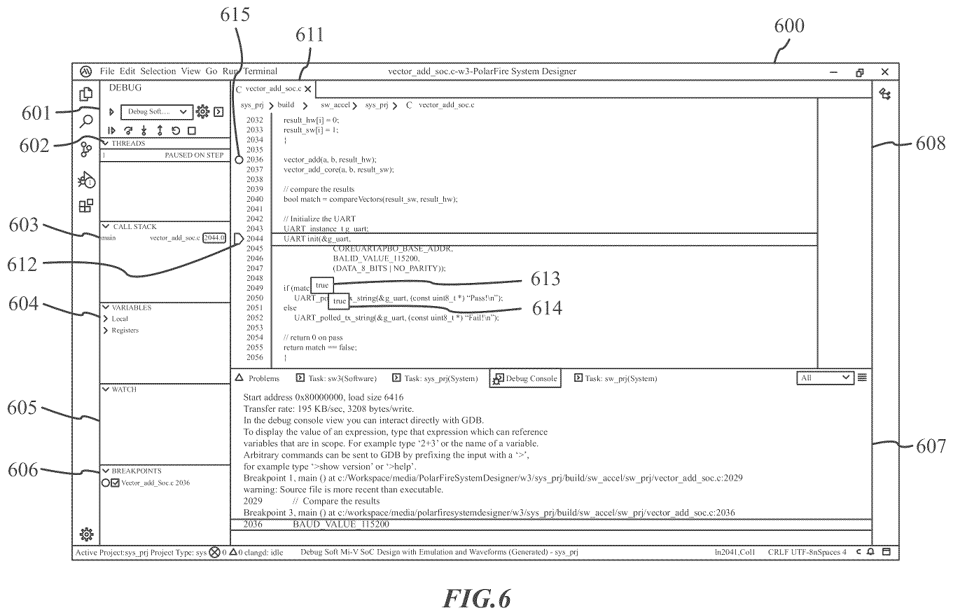

FIG. 6 illustrates a screen of an integrated development environment (IDE) including a co-simulation framework, according to certain examples. IDE 600 includes panels 601-606, console panel 607, source code listing 611, and source code thumbnail view 608. Control panel 601 provides controls for starting, advancing, and stopping the co-simulation process. Threads panel 602 allows inspection of multiple threads of execution on the emulated processor during the co-simulation process, if applicable. Call stack panel 603 provides context of the current call stack of a thread executing on the emulated processor during the co-simulation process. Current line indicator 612 may indicate in the source code view which line will be executed next in the co-simulation process. Variables panel 604 provides visibility into the values of variables and registers during the co-simulation process. Watch panel 605 provides visibility into variables or registers of specific interest during the co-simulation process. Breakpoints panel 606 provides a mechanism for setting and releasing breakpoints for a program running on the emulated processor during the co-simulation. A breakpoint may pause execution of the emulator to allow a user to observe the current execution state. In some situations, a system developer may set a breakpoint at or before a sequence of instructions that the developer wishes to observe closely during execution. Breakpoint indicator 615 may indicate in the source code view where a breakpoint has been set. IDE 600 shows how the software executing on a RISC-V emulator can be debugged with GDB to examine program variables as well as values of the RISC-V registers. Value popups 613 and 614 show an alternative mechanism to display the current value of a software variable.

Console panel 607 may provide an interactive console for interrogating the current state of the co-simulation process or for manipulating values during the co-simulation process. Console panel 607 may provide status reports on the co-simulation process. Source code thumbnail view 608 may provide a condensed view of source code listing 611 to provide a developer with context and a mechanism for quickly navigating to other portions of the source code file.

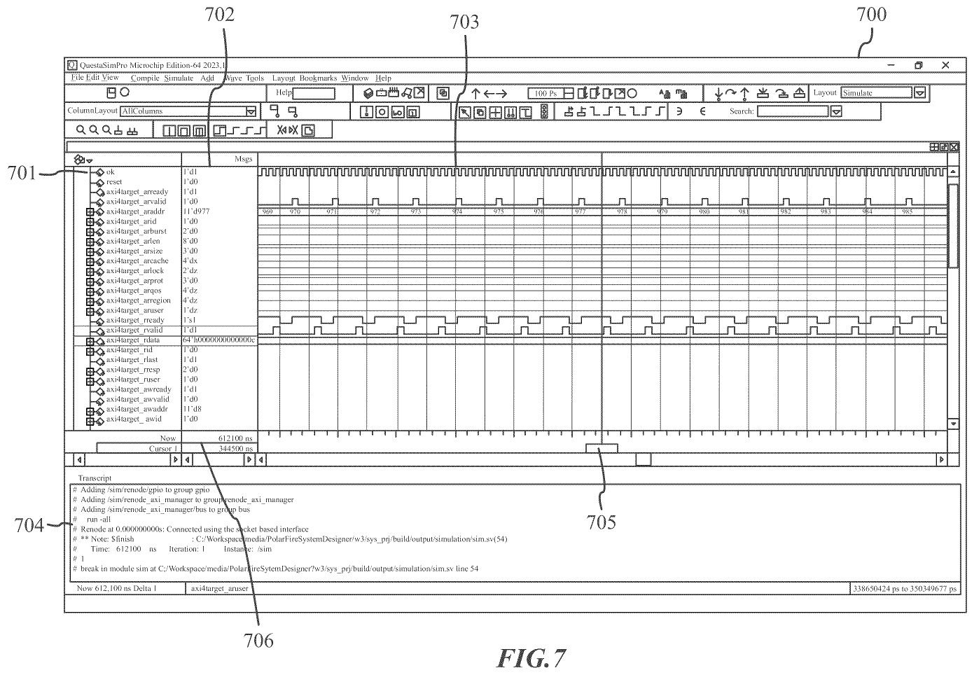

FIG. 7 illustrates a screen of an integrated development environment (IDE) including a co-simulation framework, according to certain examples. In some examples, the co-simulation also opens RTL simulation for the user to debug the cycle-by-cycle behavior of hardware. IDE 700 includes signal inspector 701 with current values 702, waveform chart 703, and transcript panel 704. Signal inspector 701 allows a developer to locate and inspect a particular signal line or grouping of signal lines (e.g., a register or bus). Current values 702 shows the current value of the signal line or grouping of lines. In some examples, current values 702 may decode information as a decimal value or a hexadecimal value. Waveform chart 703 provides a developer with visibility into the change of signal line values as a function of time. Cursor 705 provides a developer with a tool for comparing values of multiple signal lines at a particular time in the co-simulation. Current time 706 indicates the current time from the start of the co-simulation. IDE 700 shows the co-simulation may open RTL simulation for the user to debug the cycle-by-cycle behavior of hardware. In some examples, after the hardware accelerator finishes its execution, the hardware accelerator may return a computed result (or a set of computed results) back to the simulated RISC-V processor. In some examples, the hardware accelerator may continue executing asynchronously with the RISC-V processor or may synchronize on the transfer of data into or out of the hardware accelerator.

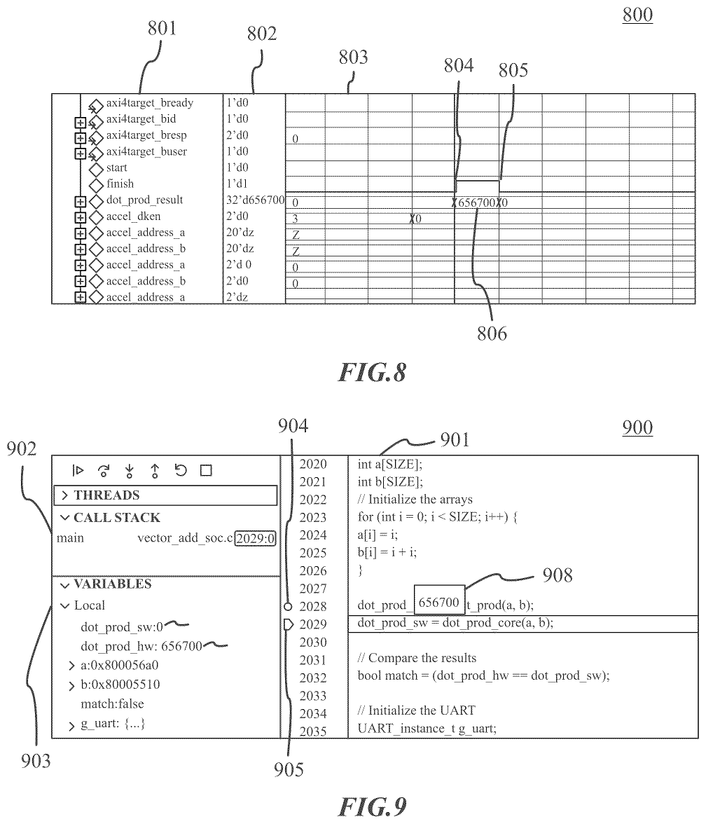

FIG. 8 illustrates a screen of an integrated development environment (IDE) including a co-simulation framework, according to certain examples. Portion of IDE 800 illustrates a detailed portion of the IDE 700. Signal inspector 801 allows a developer to locate and inspect a particular signal line or grouping of signal lines (e.g., a register or bus). Current values 802 shows the current value of the signal line or grouping of lines. Waveform chart 803 provides a developer with visibility into the change of signal line values as a function of time. At time 804, signal dot_prod_result, which is a 32-bit value, transitions from Od to 656700d for time period 806. At time 805, the signal dot_prod_result transitions back to Od. Note that some signal lines illustrated in FIG. 8 are indicated as high impedance, or Z. A user of IDE 800 may examine the computed result in RTL simulation of the hardware accelerator and verify that the same result is received correctly by the software running on the emulated RISC-V processor (as shown in FIG. 9). These examples illustrate concurrent debugging of software and hardware, which may be especially useful when debugging complex data transfers and communication protocols.

FIG. 9 illustrates a screen of an integrated development environment (IDE) including a co-simulation framework, according to certain examples. Portion of IDE 900 illustrates a detailed portion of an IDE like IDE 600. IDE 900 includes source code listing 901, threads panel 902, variables panel 903, breakpoint indicator 904, and current line indicator 905. Portion of IDE 900 illustrates the ability to hover over a variable name, e.g., dot_prod_hw, and the IDE will show the current value, e.g., 656700, in callout 908.

FIG. 10 illustrates a block diagram of the co-simulation framework, according to certain examples. Co-simulation framework 1000 includes processor emulator 1010, debugger client 1020, console 1030, and hardware simulator 1040. Processor emulator 1010 may be a RISC-V processor emulator, in some examples. Processor emulator 1010 allows code targeting one processor architecture to execute on a virtual processor that may be of the same or a different architecture. By executing a processor portion of a design on processor emulator 1010, the system can pause execution. While execution is paused, a developer may inspect the state of execution, modify memory values (e.g., register values, main memory values), and take other steps to validate or improve the implementation of the software portion of a design. Processor emulator 1010 may include debug server 1011 and memory-mapped peripherals 1012. Memory-mapped peripherals 1012 may include HLS accelerator 1013 and universal asynchronous receiver-transmitter (UART) 1014. Debug server 1011 may be a GNU Debug Server (GDB) and may provide access to debug client 1020 to inspect/modify execution or memory state and control the execution (e.g., pause, reset, step, continue). Hardware simulator 1040 may be a register transfer language (RTL) simulator. Hardware simulator 1040 may include simulator interface socket library 1042. Simulator interface socket library may use the System Verilog Direct Programming Interface (DPI). Simulator interface socket library 1042 may include a definition of data bus 1043, e.g., advanced extensible interface (AXI) bus. Hardware simulator 1040 may include a hardware definition code file 1044 (e.g., RTL file vec_add.v) defining the hardware portion of the design to be tested. Sockets 1021 enable communications between debug client 1020 and debug server 1011. Sockets 1031 enable communications between console 1030. Sockets 1041 enable communications between hardware accelerator 1013 and simulator interface socket library 1042. Sockets 1021, 1031, and 1041 may be implemented with a network sockets library to ensure lossless, ordered communication delivery between software components.

### Simulation Overview:

Once the SoC design has been generated, it may be verified through the co-simulation framework as shown in FIG. 10, where the RISC-V software binary (vec_add.elf) may communicate with the hardware accelerator (vec_add.v).

The RISC-V Co-Simulation may start four software processes that communicate using localhost TCP sockets. During simulation, the processes exchange data through the TCP communication protocol over the loopback network interface. The four software processes, shown in FIG. 10, are a GDB client and a TCP port monitor (left), a RISC-V emulator (middle), an RTL simulator (right).

In some examples, QuestaSim™ may be used as the RTL simulator. In addition to providing cycle-accurate simulation of RTL circuits, QuestaSim™ supports the System Verilog Direct Programming Interface (DPI), which allows software written in the C language to be used as part of the RTL simulation. This allows the RTL simulation to communicate with other processes using TCP sockets.

In some examples, Renode™ may be used as an open-source RISC-V emulator. The emulator allows executing RISC-V instructions and provides a DPI socket library for communicating over TCP sockets. This allows data to be communicated between the emulator and the RTL simulator. For example, once per clock cycle of the RTL simulation, a message may be sent over TCP sockets by the emulator and received by the RTL simulator. This can be used to maintain synchronization between the emulation and simulation, for example, to indicate when the processor execution is paused for debugging. The RTL simulator may wait for a message before proceeding, and then send a response to the emulator. Data may be communicated between the emulated processor and RTL simulator as AXI transactions over TCP sockets, as shown in 1043.

To begin the co-simulation, the software binary, vec_add.elf, may be run on the RISC-V emulator. This is done by connecting a GDB client to the emulator's process. The emulator receives and responds to commands from the GDB client using a GDB server. This connection is made through an automated script generated by the co-simulation framework. The GDB client allows users to enter debug commands while the software binary runs on the RISC-V emulator. For example, users can step through their code line-by-line as it executes or can examine the values of variables. The system may support running this in a command-line terminal or through the Integrated Development Environment (IDE), which provides a graphical user interface (GUI) for debugging.

Users may also print program outputs from their software application. On a physical RISC-V processor on a board, this output may be transmitted serially through a UART (universal asynchronous receiver-transmitter) communication channel. In emulation, this UART device is modeled as a peripheral device. This emulated device writes the serialized data to a TCP socket. To receive UART output and print its data to a terminal, a TCP port monitor may be used (shown in FIG. 10). This is the fourth process that is run as part of the co-simulation to read data from the TCP port and display the serialized output to the user.

The framework automatically finds 2 unused TCP ports on localhost, one for GDB communication and one for UART communication.

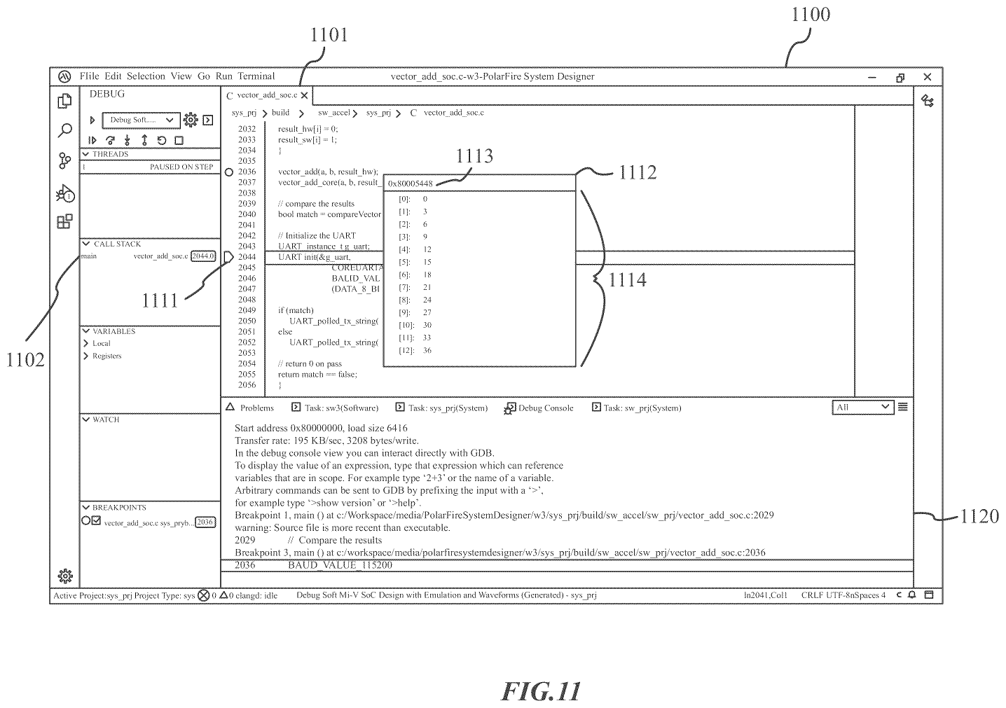

FIG. 11 illustrates a screen of an integrated development environment (IDE) including a co-simulation framework, according to certain examples. IDE 1100 includes source code listing 1101, call stack panel 1102 indicating a current execution line 2044 corresponding to current line indicator 1111, and debug console 1120. Overlaid on source code listing 1101 is array variable inspector 1112 showing array base address 1113 and array contents 1114. Debug console 1120 illustrates output from the co-simulation process.

### Software-Hardware Communication:

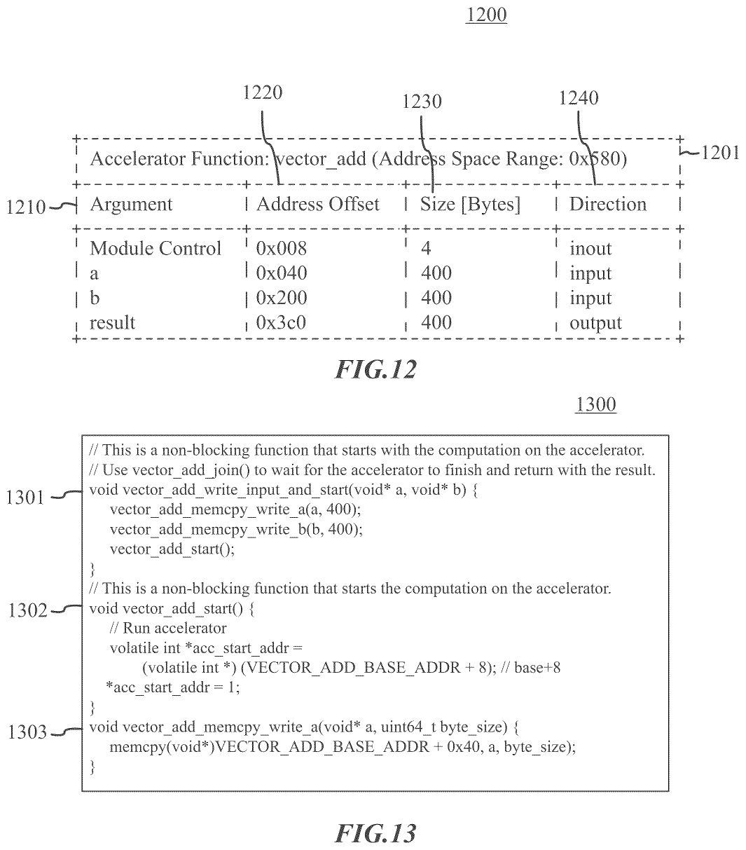

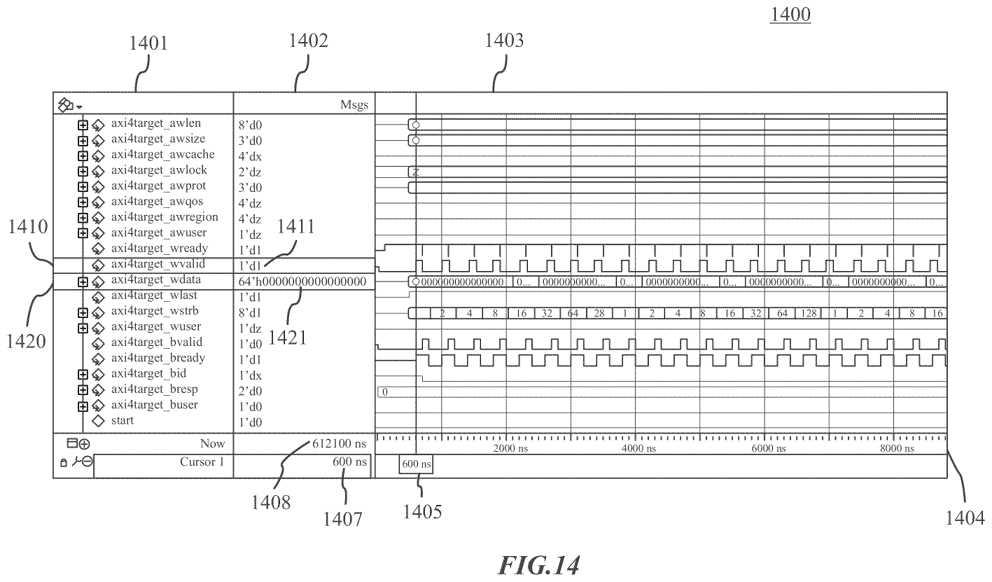

The hardware accelerator may be a memory-mapped device in the SoC design. The software and accelerator communicate by reading/writing from/to address offsets in the accelerator memory map. An example of this memory map is shown in FIG. 12. Some corresponding generated drivers are shown in FIG. 13.

FIG. 12 is an illustration of a memory map, according to certain examples. Memory map 1200 includes function identifier 1201, argument identifiers 1210, address offsets 1220, argument sizes 1230 (in bytes), and direction indicators 1240. Function identifier 1201 illustrates the name of an accelerator function-vector_add-that has been defined in a source code file and has been marked for implementation in the hardware accelerator, e.g., the configurable hardware fabric. Function identifier 1201 also displays an address space range of 0x580. This range begins at a base memory address which is input to the co-simulation framework and is a characteristic of the hardware design, e.g., 0x80100000 in FIG. 10. The base address and address space range allow instructions executing on the processor emulator to access the vector_add function and to allow the debug tools to observe and identify the control and data interactions between emulated software and simulated hardware accelerator. Argument identifiers 1210 provides names for four arguments: Module Control, a, b, and result. Address offsets 1220 lists four address offsets (within the address space range 0x580 and relative to the base address) identifying the memory mapped locations corresponding to the four arguments. These memory mapped locations may be used by the emulated software and debug tools to access, observe, and identify each of the four arguments. Argument sizes 1230 defines the size, in bytes, of each argument. Direction indicators 1240 captures the data flow direction for each argument. For example, Module Control is an inout direction, or input/output, meaning control messages may be sent to and received from the vector_add function implemented in the hardware accelerator. Arguments “a” and “b” are inputs, meaning the emulated program provides each as inputs. And the result argument is an output, meaning the emulated program receives the values in this argument as a result of the function call.

FIG. 13 is an illustration of source code, according to certain examples. The source code implements drivers for reading and writing to the accelerator. Here VECTOR_ADD_BASE_ADDR may be the base address of where the accelerator, vector addition, is located. The co-simulation framework automatically specifies the base address and the address range of the accelerator to the RISC-V emulator to correctly map and model the hardware accelerator. The drivers in the software binary can then read and write to the accelerator during emulation.

Source code excerpt 1300 includes three function calls that may be used to interact with a non-blocking function call named vector_add. Function call 1301 may be used to setup the input arguments for the vector_add function and to start the hardware accelerator. Function call 1301 begins by copying data, by calling two function calls including function call 1303, from software-defined variables “a” and “b” to memory-mapped arguments within the hardware accelerator. Function call 1303 copies the values in the emulated processor memory to memory-mapped addresses in the hardware accelerator. In this example, the contents of software-defined array “a” are copied to a memory address calculated by adding the base address of the vector add accelerator function, e.g., VECTOR_ADD_BASE_ADDR, and an offset of 0x040 (as shown in FIG. 12). Another function call, not shown, will copy the contents of software-defined array “b” to a memory address calculated by adding the base address of the vector add accelerator function, e.g., VECTOR_ADD_BASE_ADDR, and an offset of 0x200. Finally, function call 1302 will call vector_add_start ( ) to copy the scalar value of “1” to the module control argument address, which is calculated by adding an offset of 0x008 to the base address, VECTOR_ADD_BASE_ADDR. This argument will trigger the hardware accelerator to begin performing the vector add operation. Because this function is not blocking, software instructions executing on the emulated processor may continue executing without waiting for a return value. The software instructions executing on the emulated processor may determine whether the hardware accelerator function has completed by checking the module control argument for a return value signaling processing is complete.

The steps involved in communicating between the software binary and the hardware accelerator may be as follows:

First, the memcpy driver function in software is compiled to RISC-V instructions, for example, instructions “lb” and “sb” which are 8-bit load (read) and store (write) instructions respectively.

Second, the RISC-V emulator runs these instructions and, when it sees the address of the memory read or write, looks up this address in the memory map, and finds the associated device. It then calls a function to read/write from/to the associated device, which allows the emulator to initiate communication with the RTL simulator.

Third, the RISC-V emulator function initiates an AXI4 data transfer to the hardware accelerator in RTL simulation. AXI4 is an on-chip communication bus protocol. The AXI transaction is received in RTL simulation from the RISC-V emulator using a built-in RISC-V emulator library. This library is called within the simulation testbench, which also instantiates the hardware accelerator, vec_add.v.

Fourth, the AXI transaction is received by the accelerator, which responds to this AXI transaction. In this example the processor is the AXI initiator and the accelerator is the AXI target.

For the vector add example, the driver function vector_add_memcpy_write_a in FIG. 13 used memcpy in C/C++ to transfer data from RISC-V to the hardware accelerator.

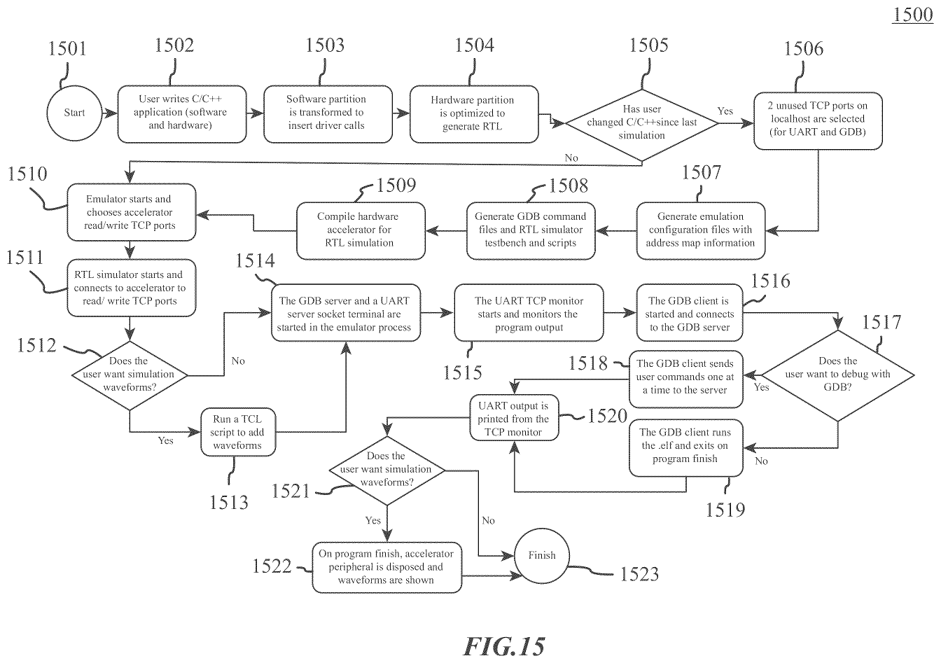

FIG. 14 illustrates a screen of an integrated development environment including a co-simulation framework, according to certain examples. Timing screen 1400 may show the simulation waveforms in the RTL simulator corresponding to this memcpy, according to certain examples. Timing screen 1400 includes signal names panel 1401, signal values panel 1402, and waveform graph 1403. Signal 1410 has a name axi4target_wvalid, which signals valid data on a wdata bus. At the currently illustrated time, one-bit signal 1410 has a decimal value of 1 (as shown in current value box 1411) indicating valid data. Signal 1420 has a name axi4target_wdata and corresponds to a 64-bit bus with a current value of 0x0000000000000000, or h0000000000000000, as shown in current value box 1421. Current time value 1408 shows a current time of 612100 ns into the co-simulation. Cursor 1 indicator 1405 marks the waveforms at a cursor time of 600 ns, illustrated in current time value 1407. Timeline 1404 illustrates the time range for waveform graph 1403.

### Automation:

In some examples, the SoC co-simulation platform may automate the entire SoC verification process, as shown in FIG. 15. At a high level, the process may flow as follows:

First, the platform chooses free ports for the UART and GDB communication and generates the required files to run simulation.
For the RISC-V emulator, the platform generates configuration files for the RISC-V emulator with the correct address map information for accelerators.
For GDB, the platform generates command files for GDB to execute commands to connect to RISC-V emulator's GDB server and to set breakpoints.
For RTL Simulator, the platform includes a SystemVerilog testbench which instantiates the generated hardware accelerator. The system may also include a mechanism to handle synchronization between the different processes.

Second, the system uses CMake to call simulator commands to compile the hardware accelerator for simulation.

Third, the system runs scripts using the open-source ROBOT FRAMEWORK to automatically run the simulation. These scripts start the required processes (GDB, RTL simulator, RISC-V emulator, UART Monitor), establish the socket connections between them on the correct ports, and handle communication and synchronization between the processes.

The steps may be as follows:
1. RISC-V emulator is started and the accelerator peripheral is assigned to read and
write socket ports.
2. RTL simulator is started and connects to these ports.
3. The emulator process starts the GDB server and a UART server socket terminal on the ports chosen by the co-simulation framework.
4. The UART TCP monitor starts and monitors the program output.
5. The GDB client is started, connects to the GDB server, and runs the software binary.
6. When the program finishes, the UART output is printed from the monitor. Also, the accelerator peripheral is disposed (closed) within the emulator and the RTL simulator displays the waveforms for the user.

### Process Synchronization:

The system also adds synchronization mechanisms for the processes to communicate properly.

First, the system generates a file once simulation begins to connect the emulator to the simulator. This file enables proper synchronization between the two tools running on separate processes, as depending on the speed of the user's machine and whether waveforms are viewed, the time when the emulator can connect to the simulator can vary.

Second, the RTL simulator may show waveforms once the accelerator peripheral is disposed, so the system disposes of the peripheral in the RISC-V emulator once the user exits GDB or the program has finished. The program finishing is detected automatically by the ROBOT FRAMEWORK when the user runs without debugging by waiting for the process to exit, and automatically by GDB during debugging by using the “commands” command which waits for a breakpoint at the end of the program to be reached and then disposes of the peripheral in the emulator. Waveforms may also be viewed while the simulation is running.

Third, the system maintains synchronization between the emulator and RTL simulator, for example, to indicate when the processor execution is paused for debugging. For example, once per clock cycle of the RTL simulation, a message may be sent over TCP sockets by the emulator and received by the RTL simulator. The RTL simulator may wait for a message before proceeding, and then send a response to the emulator.

FIG. 15 is a flowchart of a method for performing a co-simulation, according to certain examples. Method 1500 begins at start block 1501. At block 1502, a user writes a program in the C or C++ programming language that defines both software to be executed on a processor and algorithms to be implemented in the hardware accelerator. In some examples, “#pragma” statements are used to demark portions of the program that are to be transformed into a configuration of the hardware accelerator fabric. At block 1503, the program is transformed to insert driver calls that will enable communication with, for example, the hardware accelerator fabric. Other driver calls may enable socket communication with the debugger console and memory mapped devices. This step also compiles the software to generate an executable binary. At block 1504, the hardware portions of the program are optimized to generate a register transfer language (RTL) description of those portions. The RTL description may be translated into a configuration of the hardware accelerator fabric (e.g., an FPGA configuration). At block 1505, the co-simulation framework checks to see if the C/C++ source code file or files have changed since the last simulation. If no, then the method continues at block 1510. If yes, then at block 1506 the co-simulation system selects two unused transport control protocol (TCP) ports on the local machine (localhost) and assigns them to the UART and GDB communications channels. At block 1507, the co-simulation system generates emulation configuration files for the target processor emulation platform. The emulation configuration includes address map information associating memory addresses with variables and functions.

At block 1508, the co-simulation system generates GDB command files and RTL simulator testbench and scripts. These files define how the hardware accelerator and testbench will be compiled for RTL simulation, how the software binary and RTL simulation will be run, the information and signals to be monitored, and the execution flow(s) in the software emulator and the interactions with the hardware accelerator. At block 1509, the co-simulation system compiles the hardware accelerator to perform the RTL simulation. At block 1510, the co-simulation system starts the processor emulator and chooses TCP ports for read/write communications with the hardware accelerator simulator. At block 1511, the co-simulation system starts the hardware simulator and connects to the TCP ports for read/write communications with the processor emulator. At block 1512, the co-simulation system determines whether the user wants simulation waveforms. In some examples, the co-simulation system prompts the user. In some examples, the co-simulation system has a default configuration and provides for a user override (e.g., via a command line argument or configuration setting in the user interface). If no, the method continues at block 1514. If yes, at block 1513, the co-simulation system runs a tool command language (TCL) script to add waveforms to the user interface. At block 1514, the GDB server and a UART server socket terminal are started in the emulator process. At block 1515, the UART TCP monitor starts and monitors the program output. At block 1516, the GDB client starts and connects to the GDB server. At block 1517, the co-simulation system determines whether the user wishes to debug the software with GDB. If yes, at block 1518, the GDB client sends user commands one at a time to the server and the method continues to block 1520. If no, at block 1519, the GDB client runs the executable and linkable file (e.g., ELF file) and exits on program finish then the method continues at block 1520. At block 1520, the UART output is printed from the TCP monitor to a debug console or to a capture file for later review. At block 1521, if the user chooses not to review simulation waveforms (e.g., at block 1512), the method terminates at block 1523. If the user chooses to review simulation waveforms, at block 1522, on program finish, the accelerator peripheral is disposed and waveforms are shown. The method then terminates at block 1523.

Debugging from IDE:

A fourth type of process synchronization is that the system provides synchronization when running GDB debugging from the IDE. RISC-V SoC Co-Simulation can be used from command line terminal or IDE. In the command line, the GDB client runs in a terminal console that the user can interact with. In the IDE, the user interacts using buttons. In some examples, an open-source plugin, cdt-gdb-adapter, is used to convert IDE actions into GDB commands.

For this adapter to be used as a GDB client, it needs to know when the client can connect over sockets. In the command line, this connection of a GDB client can be handled automatically because all processes, including the GDB client, can be started by the same scripts, for example, scripts written in the Robot framework. By contrast, the IDE is its own process that has already started and is running asynchronously, and the GDB client is started automatically through the IDE. For example, the IDE may start the GDB client using a launch configuration specified in a launch.json file. To synchronize this IDE's GDB client with the GDB server, the IDE's launch configuration monitors the Robot output generated by the co-simulation framework and waits for a predetermined message to indicate that the server is ready for a connection.

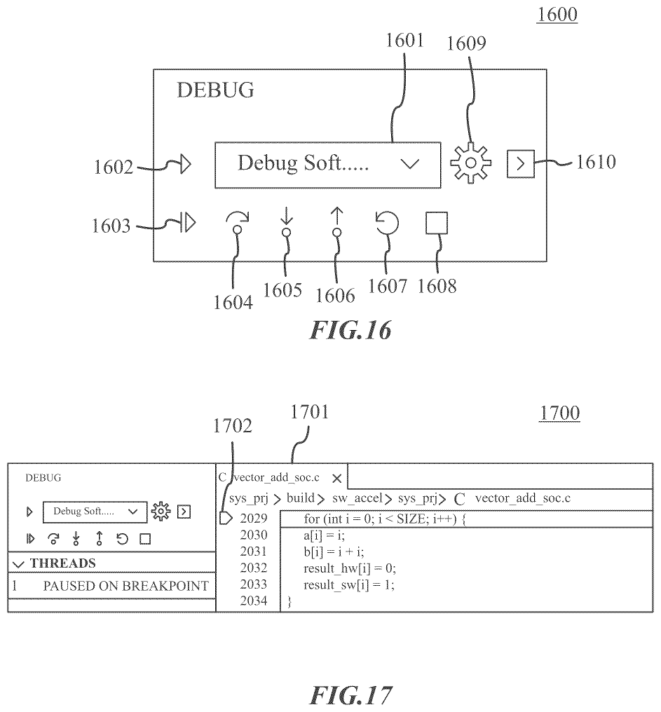

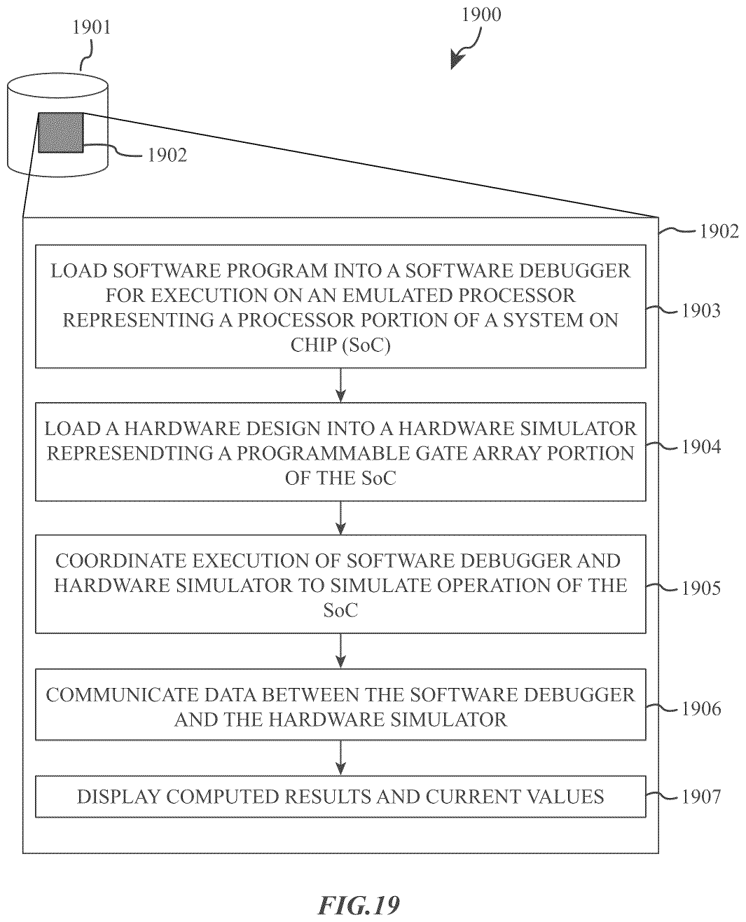

The result is that in addition to using GDB in a terminal, users can also use GDB to debug their software graphically in the IDE, as shown by FIG. 16-18. User can step through instructions and examine values of the variable, as shown in FIG. 18.

FIG. 16 is an illustration of a debugger control interface, according to certain examples. Debugger control interface 1600 includes drop down menu 1601 for selecting a mode of operation. Run button 1602 may signal to the software debugger to start executing on the processor emulator and execute on the processor emulator until the next breakpoint is reached (or an error occurs). Continue button 1603 may signal the software debugger, when paused on a breakpoint, to continue executing until the next breakpoint is reached. Step over button 1604 may signal the software debugger to execute the next line of code and, if the next line is a function call, do not step into the function call but instead proceed to the function call return. Step into button 1605 may signal the software debugger to execute the next line of code and, if the next line is a function call, step into the function call. Step out button 1606 may signal the software debugger to execute until the current function call returns. Restart button 1607 may signal the software debugger to end execution on the processor emulator, reset the debugger, and immediately restart execution at the beginning of the program. Stop button 1608 may stop the software debugger in a restartable state. Settings button 1609 may allow configuration of the debugger environment. Button 1610 may allow a user to conveniently switch the active tab at the bottom of IDE 1600 back to the debug console tab (e.g., debug console tab 1120). The Debug Console may allow the user to see the debugging output and provide any additional commands to the debugger.

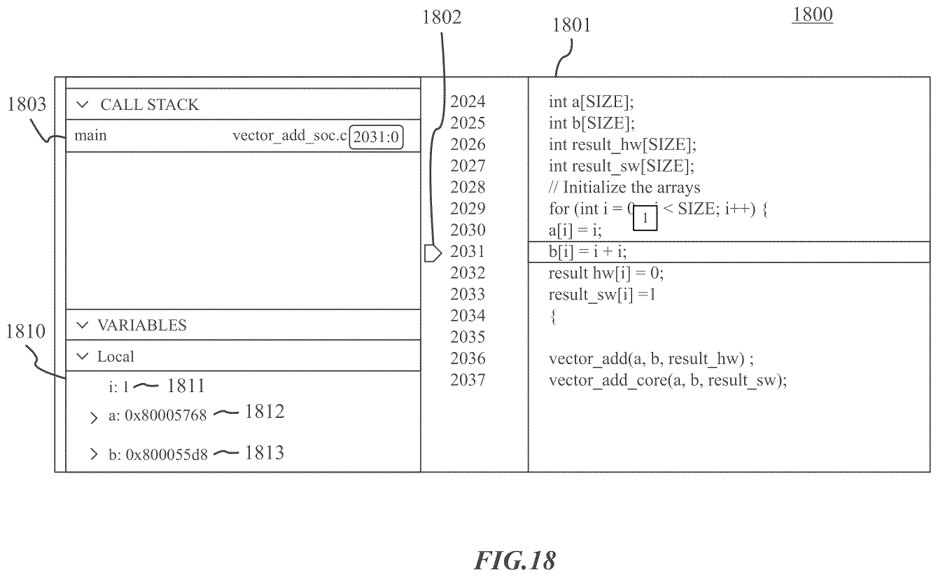

FIG. 17 illustrates a screen of an integrated development environment (IDE) including a co-simulation framework, according to certain examples. IDE 1700 includes source code listing 1701 and current line indicator 1702 indicating the simulator will execute the for loop at line 2029 when the simulation continues in the debugger environment.

FIG. 18 illustrates a screen of an integrated development environment (IDE) including a co-simulation framework, according to certain examples. IDE 1800 includes source code listing 1801 and current line indicator 1802 indicating the simulator will execute line 2031 when the simulation continues in the debugger environment. Call stack panel 1803 provides context of the current call stack of a thread executing on the emulated processor during the co-simulation process. Variables panel 1810 provides visibility into the values of variables and registers during the co-simulation process. In this example, the current value of the variable i (numeral 1811) is 1, which indicates this is the second pass through the for loop starting at line 2029. Array variables a (numeral 1812) and b (numeral 1813) are shown with starting memory addresses. Each array variable also is illustrated with a drop-down control (represented as a “>”) that allows visibility into the integer values stored in each array location.

FIG. 19 illustrates software system 1900, according to certain examples. Software system 1900 includes non-transitory computer readable medium 1901, which may be a computer drive, random access memory (RAM), a virtual drive representing cloud storage, or other storage accessible to a computer processor. Non-transitory computer readable medium 1901 may include program data 1902. Program data 1902 may be one or more files including software executable code including executable instructions. Executable instructions may be object code, byte code, interpreted script, or other representations of executable software. Program data 1902 comprises instructions that when executed on a processor perform blocks 1903-1907. Block 1903 loads a software program into a software debugger for execution on an emulated processor representing a processor portion of a system on chip (SoC). Block 1904 loads a hardware design into a hardware simulator representing a programmable gate array portion of the SoC. Block 1905 coordinates execution of software debugger and hardware simulator to simulate operation of the SoC. Block 1906 communicates data between the software debugger and the hardware simulator. Block 1907 displays computed results and current values.

Although example embodiments have been described above, other variations and embodiments may be made from this disclosure without departing from the spirit and scope of these embodiments.

What is claimed is:

1. A non-transitory computer readable medium comprising instructions that when executed on a processor:
load a software program into a software debugger for execution on an emulated processor representing a processor portion of a system on chip (SoC),
load a hardware design into a hardware simulator representing a programmable gate array portion of the SoC,
coordinate execution of software debugger and hardware simulator to simulate operation of the SoC,
communicate data between the software debugger and the hardware simulator, and
display computed results and current values.

2. The non-transitory computer readable medium of claim 1 comprising instructions that when executed on the processor:
within the software program executed in the software debugger, designate a variable as a memory value in the hardware simulator, and
after an execution step in the software debugger, set the variable in the software debugger to the current value read from the hardware simulator.

3. The non-transitory computer readable medium of claim 1 comprising instructions that when executed on the processor:
open a socket connection between the software debugger and the hardware simulator to communicate values on a simulated data bus.

4. The non-transitory computer readable medium of claim 1 comprising instructions that when executed on the processor:
convert a portion of the software program into the hardware design.

5. The non-transitory computer readable medium of claim 1 comprising instructions that when executed on the processor:
visually present at least one input to a function call to be transmitted over a socket to the hardware simulator, and
visually present an output of the function call received over the socket from the hardware simulator.

6. The non-transitory computer readable medium of claim 1 comprising instructions that when executed on the processor:
emulate memory mapped peripherals accessible to the software program.

7. The non-transitory computer readable medium of claim 1 wherein the software program is written in C or C++ code and the hardware design is specified in RTL code.

8. A computer implemented method comprising:
loading a software program into a software debugger for execution on an emulated processor,
loading a hardware design into a hardware simulator,
coordinating execution of software debugger and hardware simulator to simulate operation of a device comprising a processor and a programmable gate array,
communicating data between the software debugger and the hardware simulator, and
displaying computed results and memory values.

9. The computer implemented method of claim 8, comprising:
within the software program executed in the software debugger, designating a variable as a memory value in the hardware simulator, and
after an execution step in the software debugger, setting the variable in the software debugger to the memory value read from the hardware simulator.

10. The computer implemented method of claim 8, comprising:
opening a socket connection between the software debugger and the hardware simulator to communicate values on a simulated data bus.

11. The computer implemented method of claim 8, comprising:
accepting an input from a user to advance execution of the software debugger over a call to a function that was written in the same language of the software program and used to implement the hardware design;
sending one or more arguments from the processor emulator to the hardware simulator;
receiving a result from the hardware simulator to the processor emulator; and
displaying the result to the user.

12. The computer implemented method of claim 8, comprising:
displaying at least one input to a function call to be transmitted over a socket to the hardware simulator, and
displaying an output of the function call received over the socket from the hardware simulator.

13. The computer implemented method of claim 8, comprising:
emulating memory mapped peripherals accessible to the software program.

14. The computer implemented method of claim 8, wherein the software program is written in C or C++ code and the hardware design is specified in RTL code.

15. A non-transitory computer readable memory comprising instructions that when executed on a processor:
receive into a software debugger a software partition of a software program,
establish a first socket connection between the software debugger and a hardware simulator to simulate a hardware design corresponding to the software partition, and
execute the software partition of the software program on an emulated processor.

16. The non-transitory computer readable memory of claim 15 comprising instructions that when executed on a processor:
establish a second socket connection between the software debugger and an input/output interface.

17. The non-transitory computer readable memory of claim 15 comprising instructions that when executed on a processor:
within the software program executed in the software debugger, designate a variable as a memory value in the hardware simulator, and
after an execution step in the software debugger, set the variable in the software debugger to the memory value read from the hardware simulator.

18. The non-transitory computer readable memory of claim 15 comprising instructions that when executed on a processor:
accept an input from a user to advance execution of the software debugger over a call to a function that was written in the same language of the software program and implemented the hardware design;
send one or more arguments from the processor emulator to the hardware simulator;
receive a result from the hardware simulator to the processor emulator; and
display the result to the user.

19. The non-transitory computer readable memory of claim 18 comprising instructions that when executed on a processor:
display at least one input to a function call to be transmitted over the first socket connection to the hardware simulator, and
display an output of the function call received over the first socket connection from the hardware simulator.

20. The non-transitory computer readable memory of claim 15 comprising instructions that when executed on a processor:
emulate memory-mapped peripherals accessible to the software program.
